(19) United States
(12) Patent Application Publication
(10) Pub. No.: US 2023/0206368 A1
(43) Pub. Date: Jun. 29, 2023

(54) DISABLING SELECTED IP

(71) Applicant: Advanced Micro Devices, Inc., Santa Clara, CA (US)

(72) Inventors: Vidyashankar Viswanathan, Boxborough, MA (US); Richard E. George, Santa Clara, CA (US); Michael Y. Chow, Santa Clara, CA (US)

(73) Assignee: Advanced Micro Devices, Inc., Santa Clara, CA (US)

(21) Appl. No.: 17/565,409

(22) Filed: Dec. 29, 2021

(51) Int. Cl. G06Q 50/18

(52) U.S. Cl. CPC G06Q 50/184; G06Q 2220/18

(57) ABSTRACT

A technique for operating a processing device is disclosed. The method includes configuring at least one switch to interconnect one or more selected IP to the processing device, receiving an activation signal associated with the at least one switch based on the one or more selected IP, in response to the activation signal, causing the at least one switch to disable connection to the one or more selected IP, and verifying access to the one or more selected IP is disabled.

### BACKGROUND

Processing devices sometimes are built for multiple consumers and users. Often processing devices include custom features and IP designated for specific customers. In electronic design, a semiconductor intellectual property core (SIP core), IP core, or IP block is a reusable unit of logic, cell, or integrated circuit layout design that is the intellectual property of one party. IP cores can be licensed to another party or owned and used by a single party. Designers of processing devices, such as application-specific integrated circuits (ASIC) and systems of field-programmable gate array (FPGA) logic, can use IP cores as building blocks. The use of an IP core in chip design is comparable to the use of a library for computer programming or a discrete integrated circuit component for printed circuit board design. Each building block is a reusable component of design logic with a defined interface and behavior that has been verified by its creator and is integrated into a larger design. A building block (referred to as “selected IP”) can be software or hardware implementing a proprietary encryption or compression algorithm that is specific to a certain customer. Rather than designing and building specific processing devices for each customer to exclude the IP of other customers, a method and system of disabling selected IP would enable the designing and building of processing devices able to service a broader customer base. Techniques for facilitating such disabling is therefore important.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more disclosed aspects can be implemented;

FIG. 2 illustrates a processing device capable of irreversibly disabling custom features;

FIG. 3 illustrates an exemplary processing system including at least a first processing device, as described above with respect to the processing device of FIG. 2; and

FIG. 4 is a flow diagram of a method for disabling selected IP, according to an example.

### DETAILED DESCRIPTION

A technique for operating a processing device is disclosed. The method includes configuring at least one switch to connect one or more selected IP to the processing device, receiving, by the at least one switch, an activation signal, disabling, by the at least one switch, a connection to the one or more selected IP, and verifying the disabling of the connection to the one or more selected IP. This allows for disabling certain features of the processing device. The disabling of the features can be irreversible.

Designing and producing processing devices is an expensive endeavor. Part of the expense associated with the design and production is based on changing parameters and configurations across varied processing devices. The ability to include a multitude of selected IP including IP of a multitude of customers in a processing device, while selectively enabling/disabling the IP based on whom the processing devices are being delivered to provides great flexibility. As processing devices are built for multiple consumers and users, and the processing devices include custom features and IP designated for specific customers, rather than designing and building specific processing devices for each customer, a method and system of disabling selected custom features and IP would enable the designing and building of processing devices able to service a broader customer base.

The described systems and methods are designed to disabling certain selected features of the processing device based on the customer of the processing device.

One example method for operating a processing device is disclosed. The method for operating a processing device includes configuring at least one switch to connect one or more selected IP, including software or hardware implementing a proprietary encryption or compression algorithm that is specific to a certain customer, to the processing device, receiving an activation signal associated with the at least one switch based on the one or more selected IP, disabling, by the at least one switch, a connection to the one or more selected IP, and verifying the disabling of the connection of the one or more selected IP and the processing device.

One example system for the processing device is disclosed. The system includes a processing device configured to operate with at one or more selected IP, and at least one switch configured to connect at least one of the one or more selected IP, the at least one switch being further configured to respond to an activation signal by disabling connection to the at least the one or more selected IP. In an example, the system includes a processing device, one or more selected IP configured to operate with the processing device, and at least one switch configured to connect at least one of the one or more selected IP to the processing device, wherein the at least one switch is further configured to receive an activation signal and disable a connection of the at least one of the one or more selected IP.

In the system and method, in one example, the activation signal is based on the one or more selected IP and a customer purchasing the processing device. In an example, the configuring includes identifying one IP of the one or more selected IP that is configured to be enabled for selected customers. In an example, the configuring includes identifying one IP of the one or more selected IP that is configured to be disabled for other selected customers. In an example, the one or more selected IP implements a proprietary encryption or compression algorithm that is specific to a certain customer. In an example, the activation signal is designed to cause the at least one switch to disable the connection with the one or more selected IP. In an example, the activation signal is designated based on the one or more selected IP. In an example, the disabling of the at least one switch is irreversible.

In an example, the activation signal takes the form of a clock gating signal and the activation signal causes the designated at least one switch to disable a digital logic associated with the one or more selected IP.

In an example, the activation signal takes the form of a reset enable signal and the activation signal causes the at least one switch gates a reset to allow logic associated with the one or more selected IP to be clocked while holding the disabled one or more of the selected IP in reset.

In an example, the activation signal takes the form of an address range permission check and the activation signal causes the at least one switch to allow secured trusted firmware to read the switch and make decisions about the one or more selected IP by operating security policies to prevent loading firmware or registered data bus access to the disabled one or more of the selected IP, and.

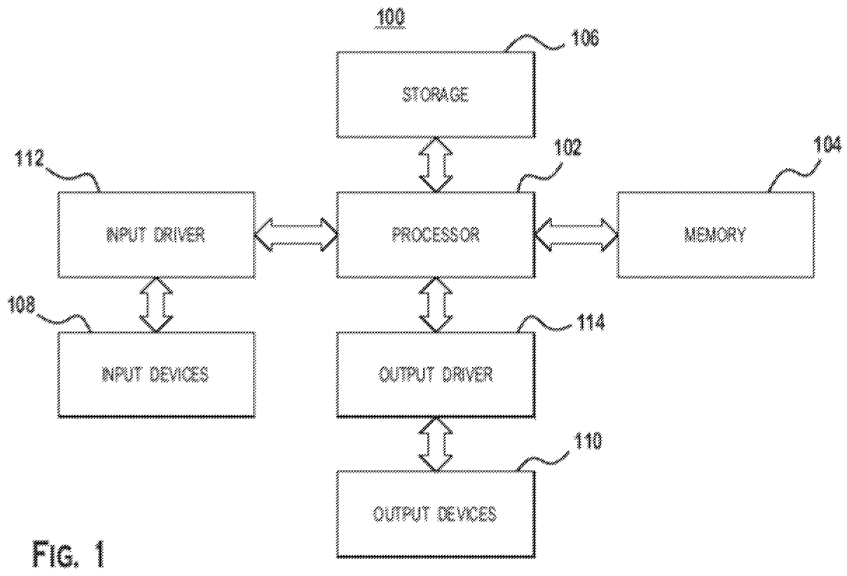

FIG. 1 is a block diagram of an example device 100 in which aspects of the present disclosure are implemented. The device 100 includes, for example, a computer, a gaming device, a handheld device, a set-top box, a television, a mobile phone, or a tablet computer. The device 100 includes a processor 102, a memory 104, a storage device 106, one or more input devices 108, and one or more output devices 110. The device 100 can also optionally include an input driver 112 and an output driver 114. It is understood that the device 100 can include additional components not shown in FIG. 1.

The processor 102 includes a central processing unit (CPU), a graphics processing unit (GPU), a CPU and GPU located on the same die, or one or more processor cores, wherein each processor core is a CPU or a GPU. The memory 104 can be located on the same die as the processor 102, or can be located separately from the processor 102. The memory 104 includes a volatile or non-volatile memory, for example, random access memory (RAM), dynamic RAM, or a cache.

The storage device 106 includes a fixed or removable storage, for example, a hard disk drive, a solid state drive, an optical disk, or a flash drive. The input devices 108 include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

Components such as the processor 102 are sometime provided with custom features. In some situations, an entity can have protected IP associated with their customer features. This protected IP can be software or hardware implementing a proprietary encryption or compression algorithm that is specific to a certain customer. In such situations, it is desirable to provide fuses to irreversibly disable the certain custom features associated with processor 102, so that the custom features with the protected IP are not provided to organizations other than the entity that owns the protected IP. Thus, a mechanism is provided herein for irreversibly disabling custom features, wherein, once disabled, the device operates without the custom features.

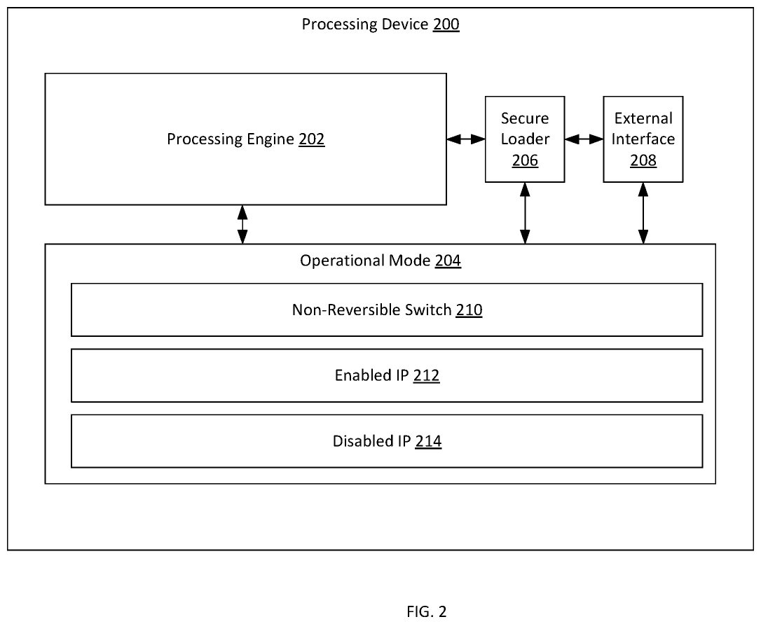

FIG. 2 illustrates a processing device 200 capable of disabling custom features (as compared with a normal operation mode, in which the processing device 200 operates normally). The disabled features can be irreversibly disabled. The processing device 200 is capable of operating in an operational mode 204 in addition to other modes (not shown). In the operational mode 204, software or other IP can be executed on the processing device 200. The software or other IP (selected IP) can be software or hardware implementing a proprietary encryption or compression algorithm that is specific to a certain customer. In an example, such an algorithm is not required for operation of the processing device for another customer allowing the selected IP to be disabled when sold to other customers. In some examples, certain fundamental IPs, such as CPU cores or memory controllers, will be enabled for all customers and do not contain any customer specific changes. In some examples, IP can be licensed IP or customer proprietary IP.

If the selected IP, communicatively coupled via a non-reversible switch 210, is attempted to be executed on the processing device 200, the processing device 200 executes that software or other IP. If the selected IP, not communicatively coupled via a non-reversible switch 210 (as is the case when the non-reversible switch 210 is disabled), is attempted to be executed on the processing device 200, the processing device 200 will not execute when the IP is software or access to the IP will be disabled and the IP is prevented from functioning when the IP is hardware. For example, across a stock-keeping unit (SKU)/OPN/Variant of products for delivery to a customer, switch 210 is disabled enabling shipment of the product without IP royalties while protecting customer propriety IP usage. As would be understood, switch 210 is enabled (or remains enabled) for the customer to whom the proprietary IP usage or rights are directed.

More specifically, in the normal operational mode 204, the processing device 200 will execute the selected IP interconnected with processing engine 202 via an enabled non-reversible switch 210. By way of example, a first selected IP can be desired to be enabled because the either IP does not have features specific to a particular customer or the selected IP is necessary for base operation of the processing device 200.

Alternatively, or additionally, in the normal operational mode 204, the processing device 200 will not execute selected IP where the interconnection with the processing engine 202 via non-reversible switch 210 is blocked or otherwise impeded because the nonreversible switch 210 is disabled. By way of an alternative example, a second selected IP is disabled because the selected IP contains features or implements algorithms that are proprietary to a specific customer. In some examples, the selected IP is not required for the operation of the system for another customer, such as disabling a peripheral controller for a peripheral that will not be present in the other system configurations. For example, disabling a display controller for a customer whose usage does not require video output.

The processing device 200 includes a processing engine 202, an operational mode 204, a secure loader 206, and an external interface 208. The operational mode 204 includes at least one non-reversible switch 210, a plurality of enabled IP 212, and a plurality of disabled IP 214.

The processing engine 202 performs the main capabilities for the processing device 200. In an example (such as where the processing device 200 is the processor 102), the processing engine 202 includes one or more execution pipelines for executing instructions for software, with components such as instruction fetch, decode, execution, memory, and writeback, or similar functionality.

The external interface 208 receives instructions from a source external to the such as a memory (e.g., memory 104 or a firmware memory such as a firmware that stores unified extensible firmware interface (“UEFI”) for boot-loading) and verifies those instructions for execution on the processing engine 202. In some examples, this verification occurs in an initial stage of operation such as during boot-loading for the processing device 200, but not after this point. In some examples, this verification occurs as a cryptographic verification, where the incoming instructions have been previously encrypted using a private key, and the secure loader 206 possesses a public key to decrypt and authenticate the incoming instructions.

The operational mode 204 cooperates with the secure loader 206 to permit or disallow normal operation of the processing device 200 in a normal mode. In the normal mode, properly enabled selected IP 212 is permitted to be executed by the processing engine 202, and the processing engine 202 is able to access any external resource such as memory, input/output devices, or other devices. Activating the non-reversible switch 210 causes the processing device 200 to operate in the operational mode 204 while disabling access to the disabled IP 214, disabled by the activation of the non-reversible switch 210. In some examples, activating the non-reversible switch 210 occurs by providing a special switch activation signal to the processing device 200 by a system external to the processing device 200. The operational mode 204 detects this switch activation signal and activates the non-reversible switch 210 in response thereby disabling the selected software or IP, such as disabled IP 214.

In some examples, activating the switch to disable software or IP involves determining that an appropriate input is received via the external interface 208. In some examples, this input is a command to disable the selected IP. In some examples, this input is verified through, for example, cryptographic verification or by receiving verification data in addition to the command. If the verification does not succeed, then the non-reversible switch 210 is not disabled and does not cause the operational mode 204 to disable the selected IP, such as enabled IP 212. If the verification does succeed, then the operational mode 204 does cause the operational mode 204 to disable the selected IP, such as disabled IP 214.

In some examples, switch 210 is designed to disable a digital logic of disabled IP 214. In another example, switch 210 gates a reset to allow the logic of the disabled IP 214 to be clocked while holding the disabled IP 214 in reset. In another example, switch 212 is a fuse allowing secured trusted firmware to read the fuse and make decisions about the disabled IP 214 by operating security policies to prevent loading firmware or registered data bus access to disabled IP 214. In an example, the switches are not connected directly to the logic. In examples, such as those presented above, the processor first reads the switch 210 macro to learn which IP is disabled, then the activation signal is derived from the fuse array to disable the IP 214. The activation signal can take the forms or methods described including a clock gating signal, a reset enable signal, and an address permission check and denying access to disabled IPs.

In an example, disabling software or IP is irreversible. Thus, after the processing device 200 renders selected IP disabled, the processing device 200 cannot later enabled that selected IP. In some examples, this irreversibility is facilitated with a fuse. When the fuse is cut, the processing device 200 is unable to access the disabled IP 214 and when the fuse is not cut, the processing device 200 can access the enabled IP 212. Once the fuse is cut, the fuse cannot be reconnected.

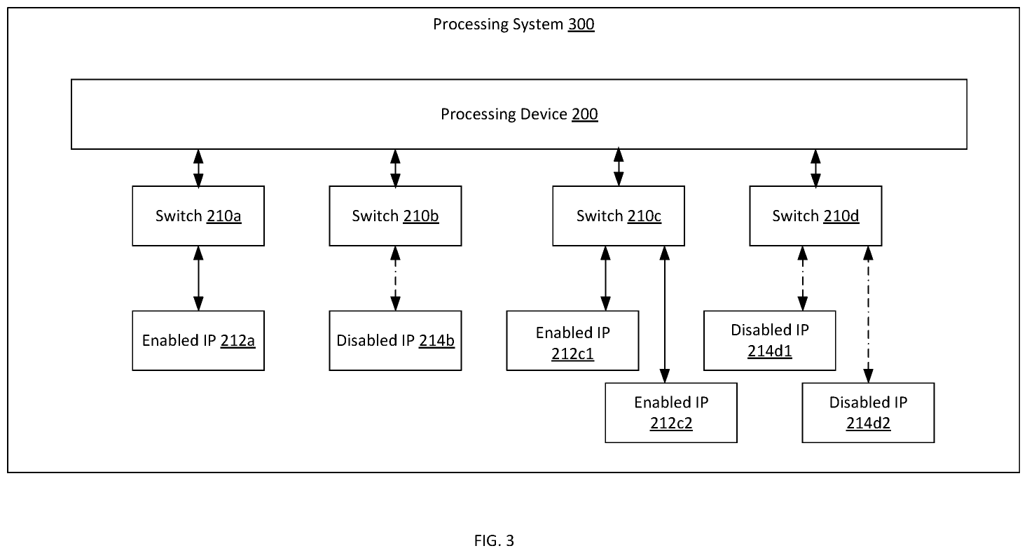

FIG. 3 illustrates and exemplary processing system 300 including at least a first processing device, as described above with respect to processing device 200. As illustrated processing device includes a plurality of switches (collectively referred to as plurality of switches 210) illustrated as a first switch 210a, a second switch 210b, a third switch 210c, and a fourth switch 210d. Each of the plurality of switches 210 can take the form of the switch 210 from FIG. 2. That is, one or more of the plurality of switches 210 disables the digital logic of enabled IP 212/disabled IP 214. One or more of the plurality of switches 210 gates the reset of the logic associated with enabled IP 212/disabled IP 214. One or more of the plurality of switches 210 allows secured trusted firmware to read the switch 210 associated with enabled IP 212/disabled IP 214.

Switch 210a is designated as controlling the enabling/disabling of a first set of IP, and as illustrated switch 210a has enabled the first set of IP, illustrated as enabled IP 212a. Switch 210b is designated as controlling the enabling/disabling of a second set of IP, and as illustrated switch 210b has been activated to disable the second set of IP, illustrated as disabled IP 214b. Switch 210c is designated as controlling the enabling/disabling of a third set of IP and a fourth set of IP, and as illustrated switch 210c has enabled the third set of IP, illustrated as enabled IP 212c1 and has enabled the fourth set of IP, illustrated as enabled IP 212c2. Switch 210d is designated as controlling the enabling/disabling of a fifth set of IP and a sixth set of IP, and as illustrated switch 210d has been activated to disable the fifth set of IP, illustrated as disabled IP 214d1 and to disable the sixth set of IP, illustrated as disabled IP 212d2.

In some examples, switches 210a, 210b, 210c, 210d are each designed as an array of switches. In some examples, the array of switches is an array of fuses. In some examples, ones of the array of fuses is blown to prevent access of the interconnected selected IP associated therewith. In some examples, the switch is addressed and when a voltage is applied to the address, the switch is blown severing the interconnectivity of the switch. In some examples, the selected IP is a secure region and is rendered nonaddressable by the switch activation and once access is blocked, reading from or writing to the secure region is prevented.

While FIG. 3 illustrates four switches, any number of switches can be used. Further, while FIG. 3 illustrates some switches 210a, 210b controlling the connectivity of a single set of IP and other switches 210c, 210d controlling two sets of IP, any number of IP can be interconnected by a switch or set of switches. In certain instances, a plurality of switches can be used to connect a single set of IP.

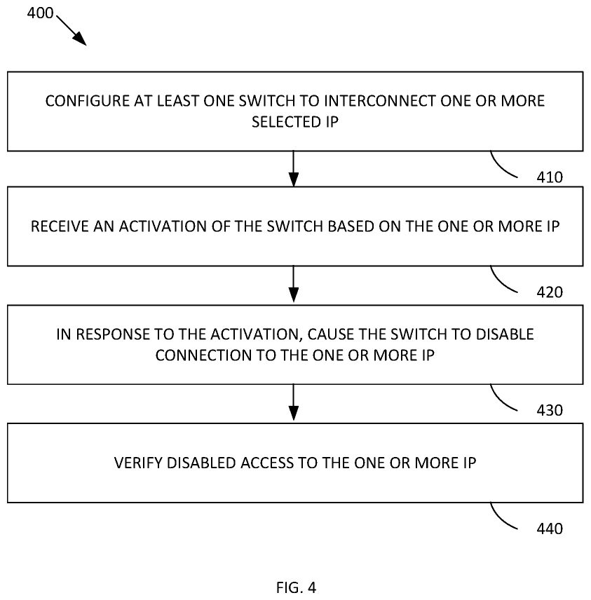

FIG. 4 is a flow diagram of a method 400 for disabling selected IP, according to an example. Although described with respect to the system of FIGS. 1-3, those of skill in the art will understand that any system, configured to perform the steps of the method 400 in any technically feasible order falls within the scope of the present disclosure.

The method 400 begins at step 410, where a processing device 200 is configured using at least one switch to interconnect one or more IP. In some examples, this step includes identifying IP that is desired to be enabled to some customers, but disabled for other customers. As described in detail above, the selected IP is software or hardware implementing a proprietary encryption or compression algorithm that is specific to a certain customer. In an example, such an algorithm is not required for operation of the processing device for another customer allowing the IP to be disabled when sold to the other customers. Certain fundamental IPs such as CPU cores or memory controllers will be enabled for all customers and can not contain any changes specific to a particular customer. In some examples, IP can be licensed IP or customer proprietary IP. In some examples, the identified IP is connected with the processing engine over a switch. In some examples, the one switch (fuse) is an array macro, which is read indirectly by the processor after boot to know which switch (fuse) is blown. In an example, the switches (fuses) are not connected directly to the logic.

At step 420, method 400 continues by receiving an activation of the switch based on the one or more IP. In some examples, the activation is a signal designed to cause the switch to disable the connection with the selected IP. In some example, the activation is designated based on the selected IP.

In some examples, where switch 210 is designed to disable the digital logic of disabled IP 214, the activation signal takes the form of clock gating signal. In another example, where switch 210 gates the reset to allow the logic of the disabled IP 214 to be clocked while holding the disabled IP 214 in reset, the activation signal takes the form of a reset enable signal. In another example, where switch 212 is a fuse allowing secured trusted firmware to read the fuse and make decisions about the disabled IP 214 by operating security policies to prevent loading firmware or registered data bus access to disabled IP 214, the activation signal takes the form of an address range permission check and denying access to disabled IPs.

At step 430, method 400 includes, in response to receiving the activation, the switch disables a connection to the one or more IP. In some examples, the switch disabling the connection is irreversible. In some examples, this step includes severing a fuse. In some examples, this step involves a disabling selected IP command. In some examples, the step also involves verifying that the activation signal is appropriate. In some examples, verifying that the activation signal is appropriate includes determining that the command is cryptographically signed according to a pre-specified private key (for example, by successfully decrypting the command via a public key).

By way of example, the fuses are disabled or blown via external interface 208 by placing the silicon chip including the processing device on a tester. The tester applies a high voltage to the designated fuse to physically disable or blow the fuse.

At step 440, the method 400 includes the processing device 200 executes or does not execute the IP based on whether the selected IP has been disabled. In some examples, the processing device 200 verifies that the selected IP is disabled. In the event that the IP is enabled, the processing device 200 executes the IP and in the event that the is disabled, the processing device 200 does not execute the IP. In some examples, if the IP is selected to be disabled and the processing device 200 can access the selected IP, method 400 reverts to step 430 to attempt to disable the selected IP.

It should be understood that many variations are possible based on the disclosure herein. Although features and elements are described above in particular combinations, each feature or element can be used alone without the other features and elements or in various combinations with or without other features and elements.

Various elements described herein are implemented as circuitry that performs the functionality described herein, as software executing on a processor, or as a combination thereof. In FIG. 1, the processor 102 is a computer processor that performs the operations described herein. The input driver 112, output driver 114, input devices 108, and output devices 110 are software executing on one or more processors, hardware, or a combination thereof. The various elements of the instruction pipeline of processing device 200 are hardware circuits. The processing engine 202, secure loader 206, external interface 208, operational mode 204, non-reversible switch 210, enabled IP 212, disabled IP 214, and processing system 300, are implemented as hard-wired circuits or as processors configured to execute software to implement the operations described herein.

The methods provided can be implemented in a general-purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for operating a processing device, the method comprising:
configuring at least one switch to connect one or more selected IP to the processing device;
receiving, by the at least one switch, an activation signal based on the one or more selected IP;
disabling, by the at least one switch, a connection of the one or more selected IP and the processing device; and
verifying the disabling of the connection of the one or more selected IP and the processing device.

2. The method of claim 1, wherein the one or more selected IP implements a proprietary encryption or compression algorithm that is specific to a certain customer.

3. The method of claim 1, wherein the activation signal is based on the one or more selected IP and a customer purchasing the processing device.

4. The method of claim 1, wherein the configuring includes identifying one IP of the one or more selected IP that is configured to be enabled to selected customers.

5. The method of claim 1, wherein the configuring includes identifying one IP of the one or more selected IP that is configured to be disabled for selected other customers.

6. The method of claim 1, wherein the activation signal is designed to cause the at least one switch to disable the connection with the one or more selected IP.

7. The method of claim 1, wherein the activation signal is designated based on the one or more selected IP.

8. The method of claim 1, wherein the activation signal is a clock gating signal and the activation signal causes the at least one switch to disable a digital logic associated with the one or more selected IP.

9. The method of claim 1, wherein the activation signal is a reset enable signal and the activation signal causes the at least one switch to gate the reset to allow logic associated with the one or more selected IP to be clocked while holding the disabled one or more of the selected IP in reset.

10. The method of claim 1, wherein the activation signal is an address range permission check and the activation signal causes the at least one switch to allow secured trusted firmware to read the at least one switch and make decisions about the one or more selected IP by operating security policies to prevent loading firmware or registered data bus access to the disabled one or more of the selected IP.

11. A system comprising:
a processing device;
one or more selected IP configured to operate with the processing device; and
at least one switch configured to connect at least one of the one or more selected IP to the processing device, wherein the at least one switch is further configured to receive an activation signal and disable a connection of the at least one of the one or more selected IP and the processing device.

12. The system of claim 11, wherein the one or more selected IP implements a proprietary encryption or compression algorithm that is specific to a certain customer.

13. The system of claim 11, wherein the at least one switch configured to connect at least one of the one or more selected IP includes identifying IP that is configured to be disabled for selected other customers.

14. The system of claim 11, wherein the activation signal is a clock gating signal and the activation signal causes the at least one switch to disable a digital logic associated with the one or more selected IP.

15. The system of claim 11, wherein the activation signal is a reset enable signal and the activation signal causes the at least one switch to gate the reset to allow logic associated with the one or more selected IP to be clocked while holding the disabled one or more of the selected IP in reset.

16. The system claim 11, wherein the activation signal is an address range permission check and the activation signal causes the at least one switch to allow secured trusted firmware to read the at least one switch and make decisions about the one or more selected IP by operating security policies to prevent loading firmware or registered data bus access to the disabled one or more of the selected IP.

17. The system of claim 11, wherein the disabled connection of the at least one switch is irreversible.

18. The system of claim 11, wherein the at least one switch is not directly connected to a processing logic of the processing device.

19. The system of claim 11, wherein the at least one switch is read to determine the disabled connection to the one or more selected IP.

20. The system of claim 19, wherein the at least one switch is read by a processor.
